(19) United States
(12) Patent Application Publication
(10) Pub. No.: US 2005/0195309 A1
(43) Pub. Date: Sep. 8, 2005

(54) Method of controlling digital photographing apparatus using voice recognition, and digital photographing apparatus using the method

(75) Inventors: Dong-hwan Kim, Seongnam-si (KR); Byung-deok Nam, Seongnam-si (KR); Hong-ju Kim, Seongnam-si (KR); Jeong-ho Lee, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/036,578

(22) Filed: Jan. 14, 2005

(30) Foreign Application Priority Data
Mar. 8, 2004 (KR) 2004-0015606

(51) Int. Cl. H04N 5/232

(52) U.S. Cl. 348/345

(57) ABSTRACT

A method of controlling a digital photographing apparatus is provided. The digital photographing apparatus includes a shutter release button having a two-step structure and the digital photographing device performs automatic focusing in a photographing mode according to a setting set by a user. First, a voice command input by the user is recognized when the shutter release button is pressed to a first step according to a manipulation of the user, and automatic focusing of an input location region is performed according the recognized voice command. Then, a photographing operation is performed when the shutter release button is pressed to a second step according to a manipulation of the user.

### BACKGROUND OF THE INVENTION

This application claims the priority of Korean Patent Application No. 2004-15606, filed on Mar. 8, 2004, in the Korean Intellectual Property Office, the disclosure of which is incorporated herein in its entirety by reference.

1. Field of the Invention

The present invention relates to a method of controlling a digital photographing apparatus and a digital photographing apparatus using the method, and more particularly, to a method of controlling a digital photographing apparatus in which automatic focusing is performed according to a setting set by a user in a photographing mode, and a digital photographing apparatus using the method.

2. Description of the Related Art

To shorten a photographing time, a location region (e.g., a center, left, or right location region) of a unit frame must be selected to automatically focus a digital photographing apparatus. However, in a conventional digital photographing apparatus, a user manipulates input buttons of the digital photographing apparatus before photographing to set a location region for automatic focusing.

An automatic focusing technique is disclosed in Korean Patent Laid-Open No. 15,719 published in 1993, entitled “Apparatus and Method of Controlling Automatic Focusing.”

### SUMMARY OF THE INVENTION

The present invention provides a method of controlling a digital photographing apparatus in which a user can easily select a location region when photographing, and a digital photographing apparatus using the method.

According to an aspect of the present invention, there is provided a method of controlling a digital photographing apparatus, the digital photographing apparatus including a shutter release button having a two-step structure and performing automatic focusing in a photographing mode according to a setting set by a user. An embodiment of the method includes two steps: recognizing a voice command input by the user when the shutter release button is pressed to a first step according to a manipulation of the user, and performing automatic focusing at an input location region according the recognized voice command; and performing a photographing operation when the shutter release button is pressed to a second step according to a manipulation of the user.

The automatic focusing is performed at an input location region according to the voice command received in the photographing mode. Thus, the user may conveniently select the input location region for automatic focusing when photographing. In addition, the voice command is recognized only when the shutter release button is pressed to the first step. Therefore, a burden on a controller due to a voice recognition operation is reduced and accuracy of the voice recognition is increased.

According to another aspect of the present invention, there is provided a digital photographing apparatus using the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating a front and top of a digital camera as a digital photographing apparatus according to an embodiment of the present invention;

FIG. 2 is a rear view of the digital camera of FIG. 1;

FIG. 3 is a block diagram of the digital camera of FIG. 1;

FIG. 4 is a schematic view of an optical system and a photoelectric converter of the digital camera of FIG. 1;

FIG. 5 is a flowchart illustrating an operation of a digital camera processor illustrated in FIG. 3;

FIG. 6 is a flowchart illustrating operations performed in a preview mode described with reference to FIG. 5;

FIG. 7 is a flowchart illustrating operations performed in a general photographing mode described with reference to FIG. 5;

FIG. 8 is a flowchart illustrating operations performed in a voice recognition photographing mode described with reference to FIG. 5;

FIG. 9 is a view illustrating exemplary location regions a user can select for automatic focusing according to an embodiment of the present invention;

FIG. 10 is a view illustrating other exemplary location regions a user can select for automatic focusing according to an embodiment of the present invention;

FIG. 11 is a flowchart illustrating a voice recognition operation described with reference to FIG. 8;

FIG. 12 is a graph for explaining the theory behind automatic focusing operations described with reference to FIGS. 7 and 8;

FIG. 13 is a flowchart illustrating the automatic focusing operations described with reference to FIGS. 7 and 8;

FIG. 14 is a graph illustrating first and second reference characteristic curves described with reference to FIG. 13;

FIG. 15 is a flowchart illustrating initializing of automatic focusing described with reference to FIG. 13;

FIG. 16 is a flowchart illustrating scanning described with reference FIG. 13;

FIG. 17 is a flowchart illustrating determination of the state of a calculated total value described with reference to FIG. 13 according to an embodiment of the present invention;

FIG. 18 is a flowchart illustrating determination of the state of a calculated total value described with reference to FIG. 13 according to another embodiment of the present invention; and

FIG. 19 is a flowchart illustrating photographing described with reference to FIG. 8.

### DETAILED DESCRIPTION OF THE INVENTION

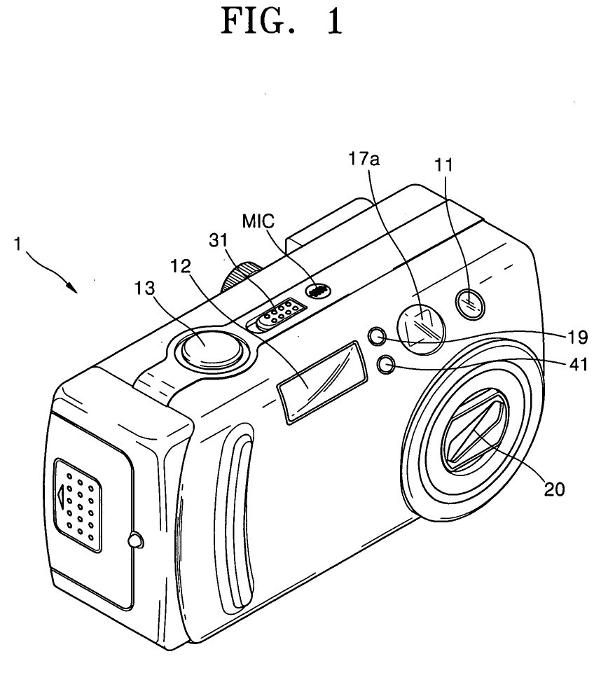

Referring to FIG. 1, a digital camera 1, which is a digital photographing apparatus according to an embodiment of the present invention, includes a self-timer lamp 11, a flash 12, a view finder 17a, a flash light-amount sensor (FS) 19, a lens unit 20, and a remote receiver 41 on its front surface; and a microphone MIC, a shutter release button 13, and a power button 31 on its top surface.

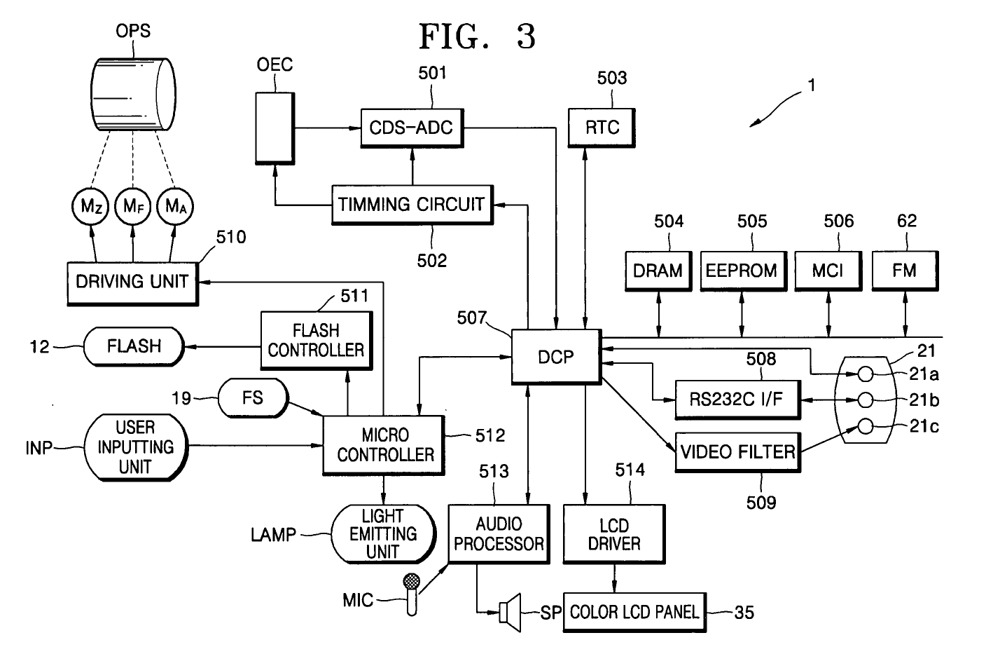

When in a self-timer mode, the self-timer lamp 11 operates for a predetermined amount of time after the shutter release button 13 is pressed until the capturing of an image begins. The FS 19 senses the amount of light when the flash 12 operates, and inputs the sensed amount into a digital camera processor (DCP) 507 (see FIG. 3) via a micro-controller 512 (see FIG. 3).

The remote receiver 41 receives an infrared photographing command from a remote control (not shown), and inputs the photographing command to the DCP 507 via the micro-controller 512.

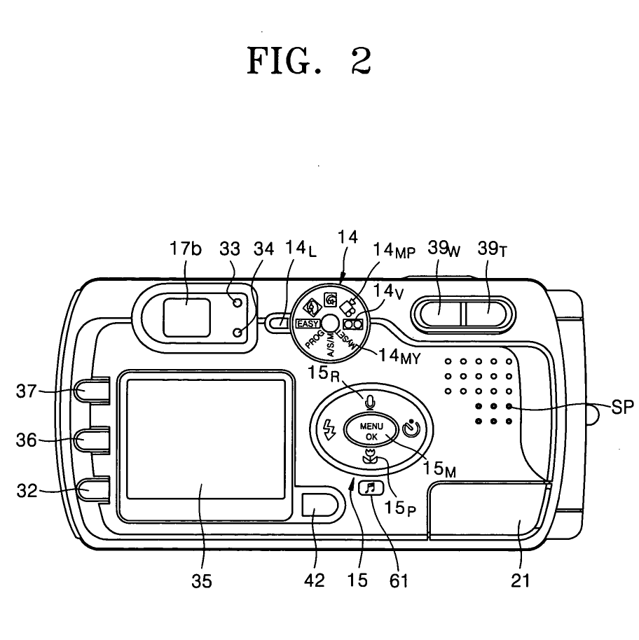

The shutter release button 13 has a two-step structure. That is, after pressing a wide-angle zoom button 39_{W} (see FIG. 2) and a telephoto zoom button 39_{T} (see FIG. 2), if the shutter release button 13 is pressed to a first step, a first signal S1 output from the shutter release button 13 is activated, and if the shutter release button 13 is pressed to the second step, a second signal S2 output from the shutter release button 13 is activated.

Referring to FIG. 2, a mode dial 14, function buttons 15, a manual-focus/delete button 36, a manual-change/play button 37, a reproducing mode button 42, a speaker SP, a monitor button 32, an automatic-focus lamp 33, a view finder 17b, a flash standby lamp 34, a color liquid crystal display (LCD) 35, the wide-angle zoom button 39_{W}, the telephoto zoom button 39_{T}, an external interface unit 21, and a voice recognition button 61 are provided at the back of the digital camera 1.

The mode dial 14 is to select and set an operating mode from a plurality of operating modes of the digital camera 1. The plurality of operating modes may include, for example, a simple photographing mode, a program photographing mode, a portrait photographing mode, a night scene photographing mode, an automatic photographing mode, a moving picture photographing mode 14_{MP}, a user setting mode 14_{MY}, and a recording mode 14_{V}. For reference, the user setting mode 14_{MY} is used by a user to set photographing information needed for a photographing mode. The recording mode 14_{V} is used to record only sound, for example, a voice of a user.

The function buttons 15 are used to perform specific functions of the digital camera 1 and to move an activated cursor on a menu screen of the color LCD panel 35.

For example, near automatic focusing is set if a user presses a macro/down-movement button 15_{P} while the digital camera 1 is in a photographing mode. If the user presses the macro/down-movement button 15_{P} while a menu for setting a condition of one of the operating modes is displayed (in response to the menu/select-confirm button 15_{M} being pressed, for example) an activated cursor moves downwards.

On the other hand, if the user presses an audio-memo/up-movement button 15_{R} while the digital camera 1 is in a photographing mode, 10 seconds of audio recording is permitted right after a photographing operation is completed. If the user presses the audio-memo/up-movement button 15_{R} while a menu for setting a condition of one of the operating modes is displayed (in response to the menu/select-confirm button 15_{M} being pressed, for example) an activated cursor moves upwards.

The manual-focus/delete button 36 is used to manually focus or delete an image when the digital camera 1 in the photographing mode. The manual-change/play button 37 is used to manually change specific conditions and perform functions such as stop or play in a reproducing mode. The reproducing mode button 42 is used when converting to the reproducing mode or a preview mode.

The monitor button 32 is used to control the operation of the color LCD panel 35. For example, if the user presses the monitor button 32 a first time when the digital camera 1 is in a photographing mode, an image of a subject and photographing information of the image is displayed on the color LCD panel 35. If the monitor button 32 is pressed a second time, power supplied to the color LCD panel 35 is blocked. Also, if the user presses the monitor button 32 for the first time when the digital camera is in a reproducing mode and while an image file is being reproduced, photographing information of the image file that is being reproduced is displayed on the color LCD panel 35. If the monitor button 32 is then pressed a second time, only an image is displayed.

The automatic-focus lamp 33 operates when an image is well focused. The flash standby lamp 34 operates when the flash 12 (see FIG. 1) is in a standby mode. A mode indicating lamp 14_{L} indicates a selected mode of the mode dial 14.

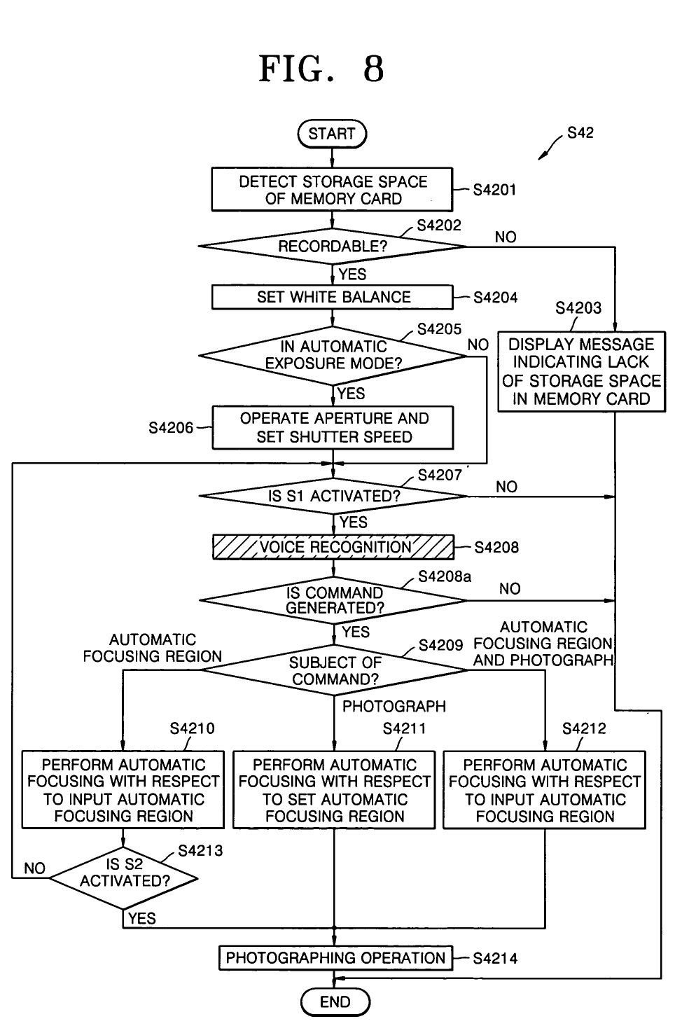

The voice recognition button 61 is used to set a voice recognition mode. Specifically, after the user presses the voice recognition button 61, a menu for setting a voice recognition mode is displayed. Here, the user selects “male” or “female” by pressing the macro/down-movement button 15_{P} or the audio-memo/up-direction button 15_{R}. Then, by pressing the menu/select-confirm button 15_{M}, the voice recognition mode is set. Photographing when the voice recognition mode is set will be described in more detail with reference to FIG. 8.

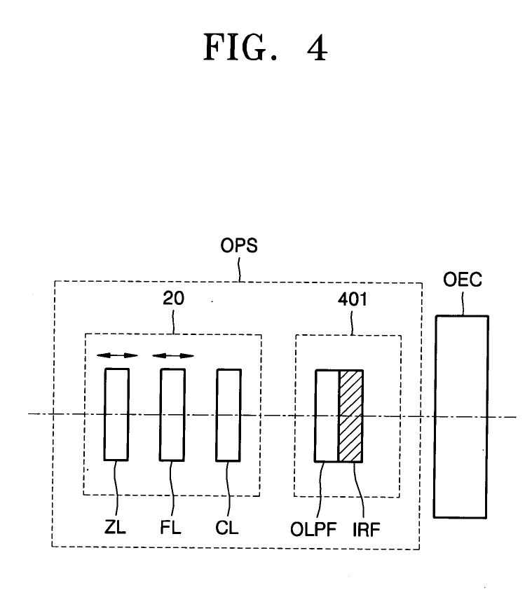

FIG. 3 is a block diagram of the digital camera 1 of FIG. 1. FIG. 4 is a schematic view of an optical system OPS and a photoelectric converter OEC of the digital camera of FIG. 1. Referring to FIGS. 1 through 4, the structure and operation of the digital camera 1 will be described.

The optical system OPS includes the lens unit 20 and a filter unit 401 and optically processes light reflected from a subject.

The lens unit 20 of the optical system OPS includes a zoom lens ZL, a focus lens FL, and a compensation lens CL.

If a user presses the wide-angle zoom button 39_{W} or the telephoto zoom button 39_{T} included in a user inputting unit INP, a signal corresponding to the wide-angle zoom button 39_{W} or the telephoto zoom button 39_{T} is input to the micro controller 512. Accordingly, as the micro controller 512 controls a driving unit 510, a zoom motor M_{Z} operates, thereby controlling the zoom lens ZL. That is, if the wide-angle zoom button 39_{W} is pressed, a focal length of the zoom lens ZL is shortened, thereby increasing a view angle. Conversely, if the telephoto zoom button 39_{T} is pressed, a focal length of the zoom lens ZL is lengthened, thereby decreasing the view angle. Since the location of the focus lens FL is controlled while the location of the zoom lens ZL is fixed, the view angle is hardly affected by the location of the focus lens FL.

In an automatic focusing mode, a main controller (not shown) embedded in the DCP 507 controls the driving unit 510 via the micro-controller 512, and thus operates a focus motor M_{F}. Accordingly, the focus lens FL moves, and in this process, the location of the focus lens FL at which high frequency components of an image signal is the largest, for example, the number of driving steps of the focus motor M_{F}, is set. To shorten a photographing time, a location region (e.g., the center, left, or right location region) of a unit frame is selected, and at the location region, the number of location of the focus lens FL at which high frequency components of an image signal is the highest (e.g., driving steps of the focus motor M_{F}) is set.

The compensation lens CL of the lens unit 20 of the optical system OPS compensate for a refractive index, and thus does not operate separately. A motor M_{A} drives an aperture (not shown).

The filter unit 401 of the optical system OPS including an optical low pass filter that removes optical noise of the high frequency components, and an infrared cut filter that blocks infrared components of incident light.

The photoelectric converter OEC is included in a charge couple device (CCD) or a complementary metal oxide semiconductor (CMOS) (not shown) and converts light from the optical system OPS into electrical analog signals. A timing circuit 502 of the DCP 507 is used to control the operation of the photoelectric converter OED and an analog-to-digital converter (ADC) 501, which is a correlation double sampler and analog-to-digital converter (CDS-ADC). The CDS-ADC processes the analog signals output from the photoelectric converter OEC, and converts them into digital signals after removing high frequency noise and altering the bandwidths of the analog signals.

A real-time clock (RTC) 503 provides time information to the DCP 507. The DCP 507 processes the digital signals output from the CDS-ADC 501, and generates digital image signals that are divided into brightness and chrominance signals.

A light emitting unit LAMP that is operated by the micro-controller 512 according to control signals output from the DCP 507 in which the main controller is embedded includes the self-timer lamp 11, the automatic-focus lamp 33, the mode indicating lamp 14_{L}, and the flash standby lamp 34. The user inputting unit INP includes the shutter release button 13, the mode dial 14, the function buttons 15, the monitor button 32, the manual-focus/delete button 36, the manual-change/play button 37, the wide-angle zoom button 39_{W}, and the telephoto zoom button 39_{T}.

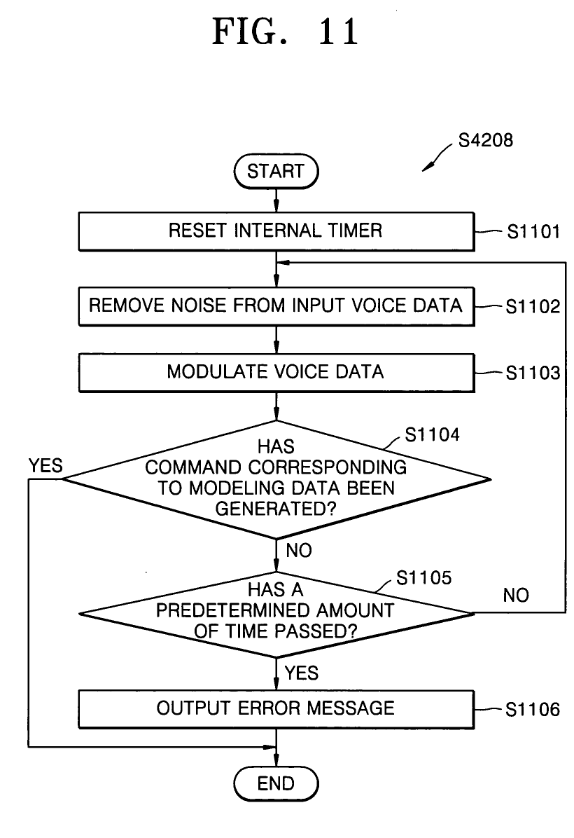

The digital image signal transmitted from the DCP 507 is temporarily stored in a dynamic random access memory (DRAM) 504. Procedures needed for the operation of the DCP 507 are stored in an electrically erasable and programmable read-only memory (EEPROM) 505. A voice recognition procedure, which will be described with reference to FIG. 11, is included in the procedures. A memory card is inserted into and detached from a memory card interface (MCI) 506. Setting data needed for the operation of the DCP 507 is stored in a flash memory (FM) 62. Modelling data for voice recognition is included in the setting data (see S1104 of FIG. 11).

The digital image signals output from the DCP 507 are input to an LCD driving unit 514 and an image is displayed on the color LCD panel 35.

The digital image signals output from the DCP 507 can be transmitted in series via a universal serial bus (USB) connector 21a or an RS232C interface 508 and its connector 21b, or can be transmitted as video signals via a video filter 509 and a video outputting unit 21c. The DCP 507 includes a main controller (not shown).

An audio processor 513 outputs audio signals from a microphone MIC to the DCP 507 or a speaker SP, and outputs audio signals from the DCP 507 to the speaker SP.

The micro-controller 512 operates the flash 12 by controlling a flash controller 511 according to a signal output from the FS 19.

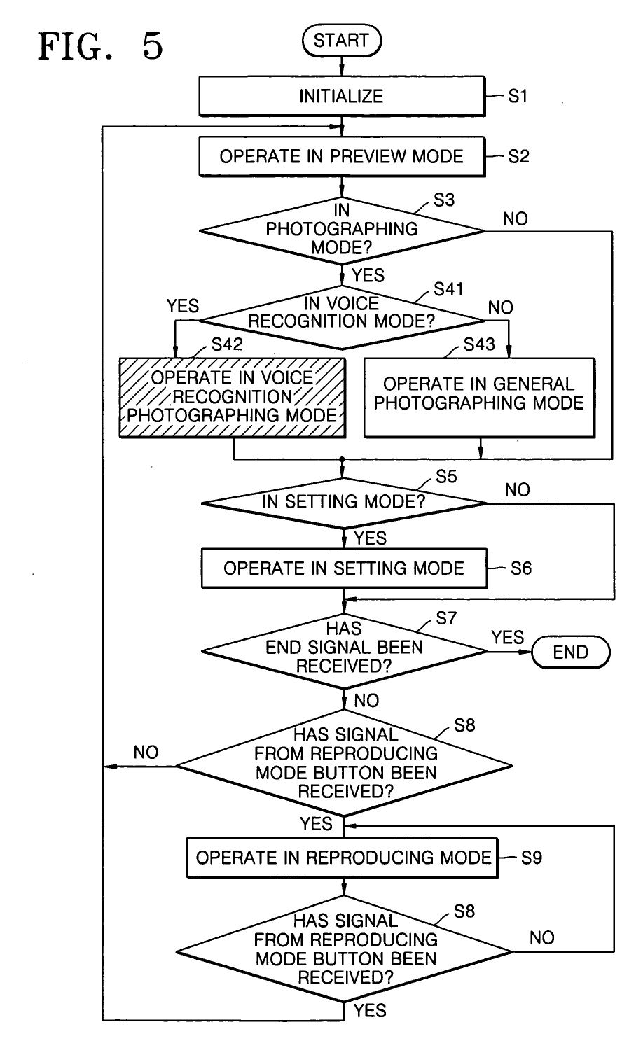

FIG. 5 is a flowchart illustrating the operation of the DCP 507 illustrated in FIG. 3. The operation of the DCP 507 will now be described with reference to FIGS. 1 through 5.

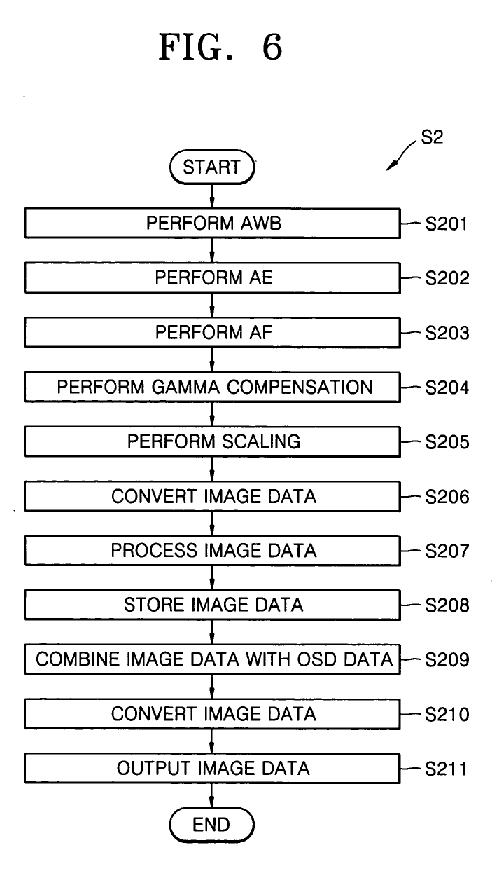

When power for operation is supplied to the digital camera 1, the DCP 507 performs initialization (S1), after which the DCP 507 enters a preview mode (S2). An input image is displayed on the color LCD panel 35 in the preview mode. Operations related to the preview mode will be described in more detail with reference to FIG. 6.

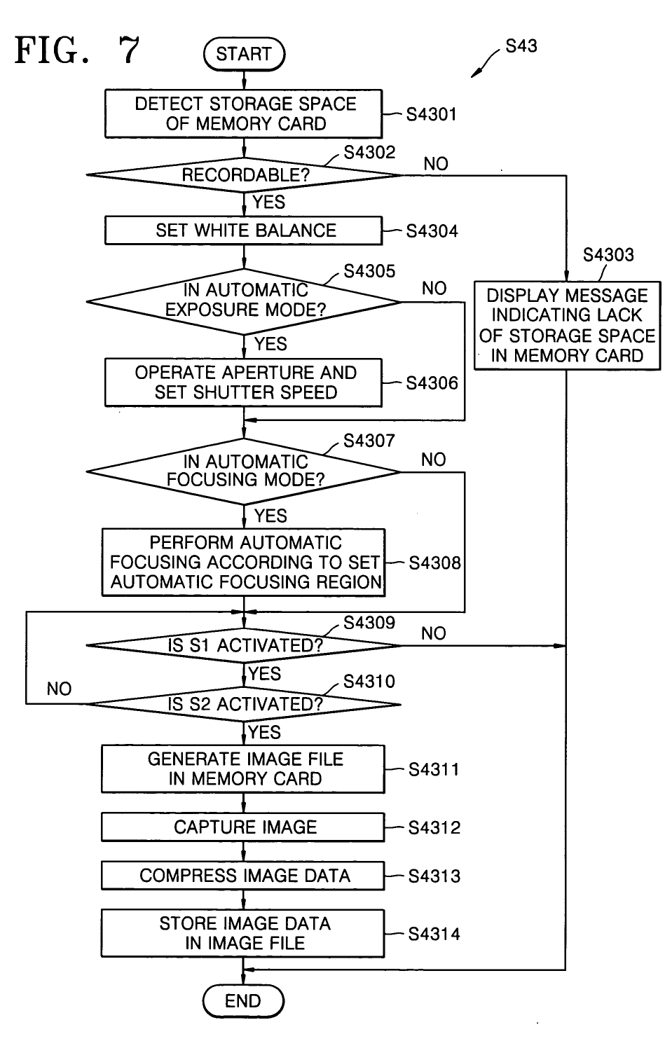

If the digital camera 1 is in a photographing mode (S3), the DCP 507 determines whether a voice recognition mode is set (S41) and enters a voice recognition photographing mode (S42) (if the voice recognition mode is set) or a general photographing mode (S43) (if the voice recognition mode is not set). Operations performed in the voice recognition photographing mode (S42) will be described later with reference to FIGS. 8 through 11. Operations performed in the general photographing mode (S43) will be described later with reference to FIG. 7.

When signals corresponding to a setting mode are received from the user inputting unit INP (S5), the digital camera 1 operates in the setting mode. In the setting mode, the digital camera 1 sets operating conditions according to the input signals transmitted from the user inputting unit INP (S6).

The DCP 507 performs the following operations if an end signal is not generated (S7).

When a signal is generated by the reproducing mode button 42, which is included in the user inputting unit INP (S8), a reproducing mode is entered (S9). In the reproducing mode, operating conditions are set according to input signals output from the user inputting unit INP, and the reproducing operation is performed. When a signal output from the reproducing mode button 42 is generated again (S10), the above operations are repeated.

FIG. 6 is a flowchart illustrating operations performed in the preview mode at step S2 of FIG. 5. These operations will be described with reference to FIG. 6 and with reference to FIGS. 1 through 3.

First, the DCP 507 performs an automatic white balance (AWE), and sets parameters related to white balance (S201).

If the digital camera 1 is in an automatic exposure (AE) mode (S202), the DCP 507 calculates the exposure by measuring incident luminance, and sets a shutter speed by driving the aperture driving motor M_{A} according to the calculated exposure (S203).

Then, the DCP 507 performs gamma compensation on the input image data (S204), and scales the gamma compensated input image data so that the image fits in the display (S205).

Next, the DCP 507 converts the scaled input image data from red-green-blue data to brightness-chromaticity data (S206). The DCP 507 processes the input image data according to, for example, a resolution and a display location, and performs filtering (S207).

Afterwards, the DCP 507 temporarily stores the input image data in the DRAM 504 (see FIG. 3) (S208).

The DCP 507 combines the input image data temporarily stored in the DRAM 504 with on-screen display (OSD) data (S209). Then, the DCP 507 converts the combined image data from brightness-chromaticity data to red-green-blue data (S210), and outputs the image data to the LCD driving unit 514 (see FIG. 3) (S211).

FIG. 7 is a flowchart illustrating operations performed in the general photographing mode at step S43 of FIG. 5. Referring to FIGS. 1 through 3 and 7, the general photographing mode is started when the first signal S1 is activated, which occurs when the shutter release button is pressed to a first step. Here, the current location of the zoom lens ZL (see FIG. 4) is already set.

First, the DCP 507 detects the remaining storage space of the memory card (S4301), and determines whether it is sufficient to store digital image signals (S4302). If there is not enough storage space, the DCP 507 causes a message to be displayed on the LCD panel 35 indicating that there is a lack of storage space in the memory card (S4103), and then terminates the photographing mode. If there is enough storage space, the following operations are performed.

The DCP 507 sets a white balance according to the currently set photographing conditions, and sets parameters related to the white balance (S4304).

If the digital camera 1 is in the AE mode (S4305), the DCP 507 calculates the exposure by measuring incident luminance, driving the aperture driving motor M_{A} according to the calculated exposure, and setting a shutter speed (S4306).

If the digital camera 1 is in the AF mode (S4307), the DCP 507 performs automatic focusing at a set location region and drives the focus lens FL (S4308). The set location region is a location region set by pushing input buttons included in the user inputting unit INP before photographing.

The DCP 507 performs the following operations when the first signal S1 is activated (S4309).

First, the DCP 507 determines whether the second signal S2 is activated (S4310). If the second signal S2 is not activated, the user has not pressed the shutter release button to the second step. Thus the DCP 507 repeats operations S4305 through S4310.

If the second signal S2 is activated, the user has pressed the shutter release button 13 to the second step, and thus the DCP 507 generates an image file in the memory card, which is a recording medium (S4311). The DCP 507 continually captures an image (S4312). That is, the DCP 507 receives image data from the CDS-ACD 501. Then, the DCP 507 compresses the received image data (S4313), and stores the compressed image data in the image file (S4314).

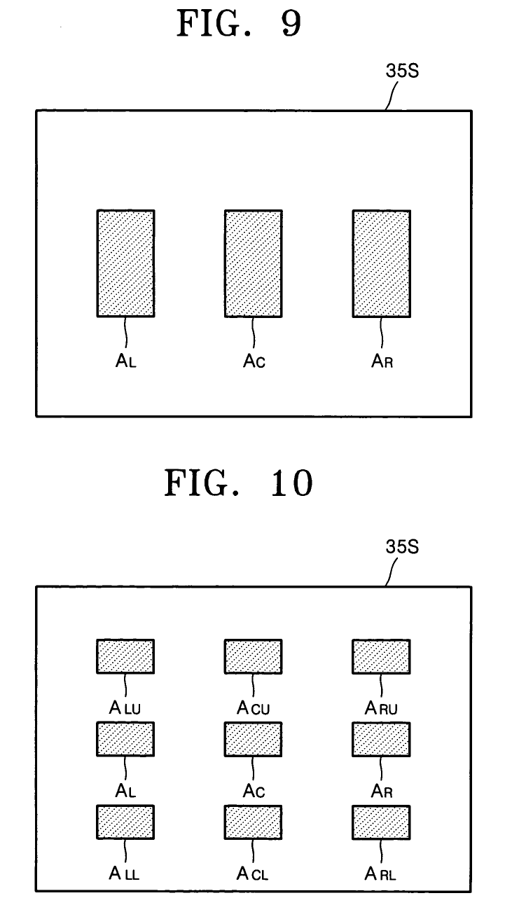

FIG. 8 is a flowchart illustrating operations performed in the voice recognition photographing mode (S42) described with reference to FIG. 5. FIG. 9 is a view illustrating exemplary location regions a user can select for automatic focusing. FIG. 10 is a view illustrating other exemplary location regions a user can select for automatic focusing. Referring to FIGS. 1 through 3, and FIGS. 8 through 10, the operations performed in the voice recognition photographing mode (S42) described with reference to FIG. 5 will now be described.

First, the DCP 507 detects the remaining storage space of the memory card (S4201), and determines whether it is sufficient to store digital image signals (S4202). If there is not enough storage space, the DCP 507 indicates that there is a lack of storage space in the memory card, and then terminates the photographing mode (S4203). If there is enough storage space, the following operations are performed.

The DCP 507 sets white balance according to the currently set photographing conditions, and sets parameters related to the white balance (S4204).

When the digital camera 1 is in the AE mode (S4205), the DCP 507 calculates the exposure by measuring incident luminance, drives the aperture driving motor M_{A} according to the calculated exposure, and sets a shutter speed (S4206).

The DCP 507 performs the following operations if the first signal S1 is activated in response to the shutter release button 13 being pressed to the first step (S4207).

First, the DCP 507 performs voice recognition and recognizes audio data from the audio processor 513 (S4208). The voice recognition procedure will be described with reference to FIG. 11.

When a command is generated according to the result of the voice recognition (S4208a), the DCP 507 determines a subject of the generated command (S4209).

If the subject of the generated command is for a location region for automatic focusing, the DCP 507 performs automatic focusing based on an input location region (S4210). If, for example, the location regions for automatic focusing are divided into a left location region A_{L}, a center location region A_{C}, and a right location region A_{R} as illustrated on a screen 35S of the color LCD panel 35 illustrated in FIG. 9, modeling data corresponding to audio data “left,” “center,” and “right” is stored in the FM 62. Accordingly, when a user says “left,” while pressing the shutter release button 13 to the first step, the DCP 507 performs automatic focusing at the left location region A_{L}, when the user says “right,” the DCP 507 performs automatic focusing at the right location region A_{R}, and when the user says “center,” the DCP 507 performs automatic at to the center location region A_{C}.

In another example, if the location regions for automatic focusing are divided into a top left location region A_{LU}, a top center location region A_{CU}, a top right location region A_{RU}, a mid-left location region A_{L}, a mid-center location region A_{C}, a mid-right location region A_{R}, a bottom left location region A_{LL}, a bottom center location region A_{CL}, and a bottom right location region A_{RL} as illustrated on the screen 35S of the color LCD panel 35 illustrated in FIG. 10, modeling data corresponding to audio data “top left,” “top center,” “top right,” “mid-left,” “mid-center,” “mid-right,” “bottom left,” “bottom center,” and “bottom right” is stored in the FM 62. Accordingly, if a user says one of the commands while pressing the shutter release button 13 to the first step, the DCP 507 performs automatic focusing at an input location region corresponding to the voice command.

After performing the automatic focusing with respect to the input location region as described-above (S4210), if the second signal S2 is activated in response to the shutter release button 13 being pressed to the second step (S4213), the DCP 507 performs photographing operations (S4214). If the second signal S2 is inactivated, operations S4207 through S4213 are repeated.

If the subject of the generated command is a photographing command, the DCP 507 performs automatic focusing with respect to set location regions and operates the focus lens FL (S4211). As described above, the set location region denotes the location region that is set by manipulating the input buttons included in the user inputting unit INP before photographing. Examples of the photographing commands include “photograph” or “cheese.” Then, the DCP 507 performs photographing operations regardless of the state of the second signal S2 (S4214).

If the subject of the generated command is a combination of the location region and a photographing command, the DCP 507 performs automatic focusing with respect to the input location region as described in S4210(S4212). When location regions are allocated as illustrated in FIG. 9, examples of a combined command includes “photograph left,” “photograph right,” and “photograph center.” Then, the DCP 507 performs photographing operations regardless of the state of the second signal S2 (S4214).

The voice recognition operation of step 4208 of FIG. 8 will now be described with reference to FIG. 11.

First, the DCP 507 resets an internal timer to limit a voice input time (S1101). The DCP 507 removes noise of input voice data (S1102), and then modulates the voice data with the noise removed into modeling data (S1103). For example, 8 kHz pulse code modulated audio data is modulated into 120-200 Hz audio data in an interval data form.

The DCP 507 checks whether the modulated data is included in modeling data stored in the FM 62, and determines a command corresponding to which modeling data is generated (S1104). When the command is generated, the DCP 507 stops the voice recognition operation (S4208) to perform the generated command.

When the command is not generated, the DCP 507 repeats operations S1102 through S1104 until a predetermined amount of time has passed (S1105). If a command is not generated even after the predetermined amount of time has passed, the DCP 507 outputs an error message, and terminates the voice recognition operation (S4208) (S1106). Examples of the error message may include “speak louder,” “too much noise,” “speak faster,” “speak slower,” “repeat,” and “input command.” Accordingly, the user may input the command again while pressing the shutter release button 13 to the first step.

FIG. 12 is a graph for explaining the theory behind the automatic focusing operations of steps S4210, S4211, S4212, and S4308 of FIGS. 7 and 8. In FIG. 12, DS denotes a number of driving steps of the focus lens FL (see FIG. 4), and FV denotes focus value proportional to an amount of high frequencies in an image signal at the input location regions or the set location regions. DS_{I} denotes the number of driving steps of the focus lens FL corresponding to a maximum set distance, DS_{FOC} denotes the number of driving steps of the focus lens FL corresponding to a maximum focus value FV_{MAX}, and DS_{S} denotes the number of driving steps of the focus lens FL corresponding to a minimum set distance. Referring to FIG. 12, in the automatic focusing steps S4210, S4211, S4212, and S4308 of FIGS. 7 and 8, the DCP 507 performs scanning in a predetermined scanning distance region between DS_{I} and DS_{S}, finds the maximum focus value FV_{MAX}, and moves the focus lens FL based on the number of driving steps DS_{FOC} Of the focus lens that corresponds to the distance where the maximum focus value FV_{MAX} is obtained.

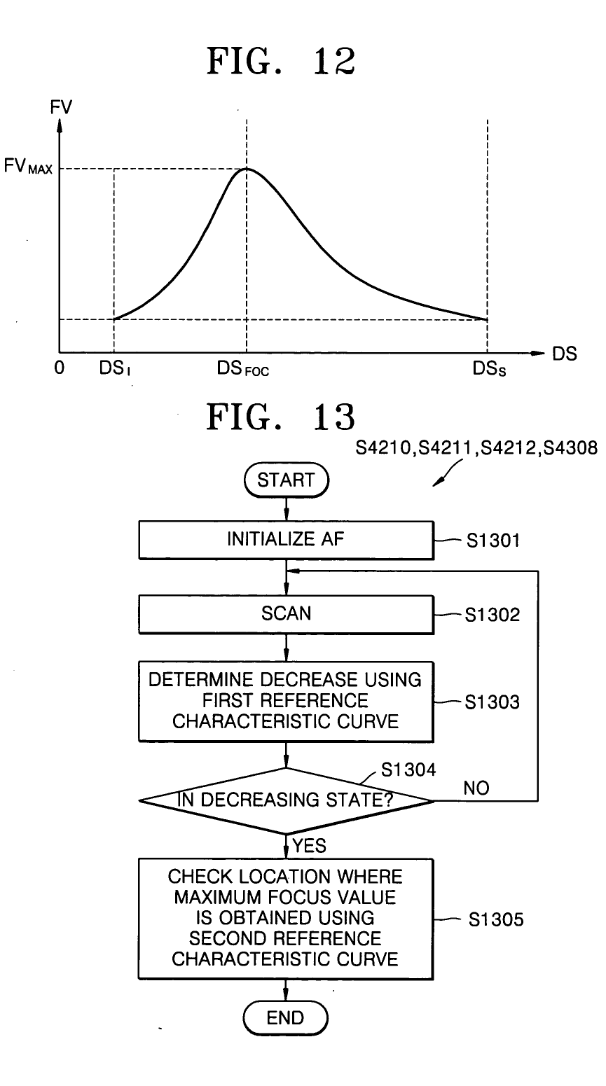

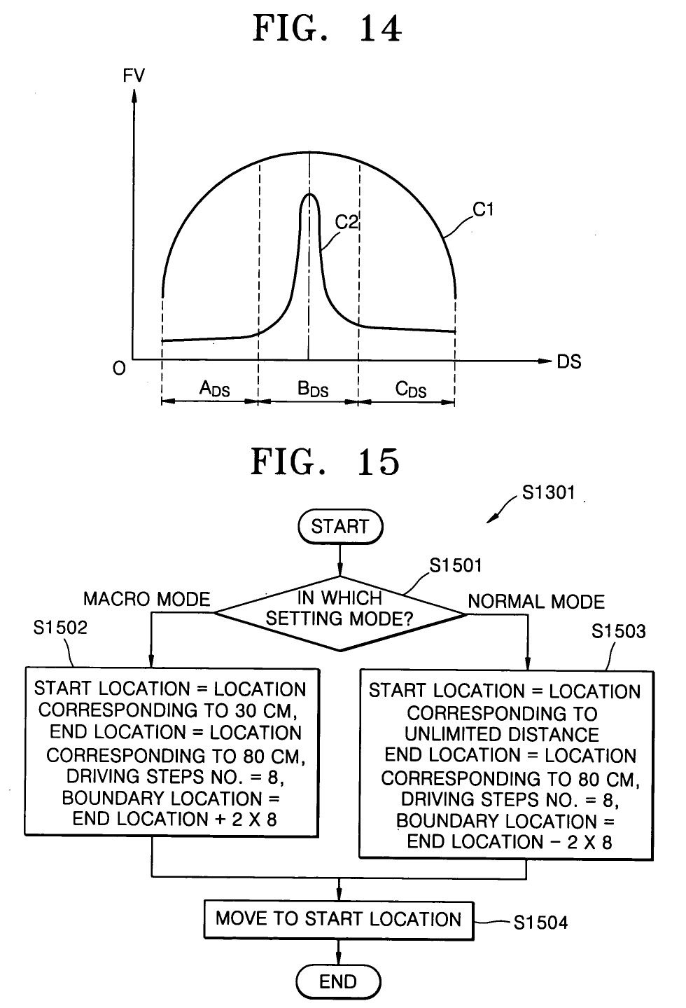

FIG. 13 is a flowchart illustrating the automatic focusing operation steps S4210, S4211, S4212, and S4308 of FIGS. 7 and 8. FIG. 14 illustrates first and second reference characteristic curves C1 and C2 used in steps S1303 and S1305 of FIG. 13. In FIG. 14, DS denotes a number of driving steps of the focus lens FL, FV denotes a focus value, C1 denotes the first reference characteristic curve, C2 denotes the second reference characteristic curve, B_{DS} denotes a scanning distance region in which the second reference characteristic curve C2 is used near the finally set maximum focus value, and A_{DS} and C_{DS} denote scanning distance regions in which the first reference characteristic curve C1 is used. The automatic focusing steps S4210, S4211, S4212, and S4308 of FIGS. 7 and 8 will now be described in more detail with reference to FIGS. 13 and 14.

First, the DCP 507 performs initializing for automatic focusing (S1301). Then, the DCP 507 scans the input location region or the set location region (S1302).

In the scanning operation (S1302), if a user has set the digital camera 1 to operate in a macro mode when a subject is located within a first distance range from the focus lens FL, for example, 30-80 cm, a scanning is performed on a location region of the focus lens FL corresponding to the first distance range. If a user has set the digital camera 1 to operate in a normal mode when a subject is not located within the first distance range, for example, is located beyond 80 cm, scanning is performed on a location region of the focus lens FL corresponding to a distance beyond the first distance range. In both the macro-mode scanning and the normal-mode scanning performed in the scanning operation (S1302), the DCP 507 calculates a focus value proportional to an amount of high frequencies in an image signal in units of a first number of driving steps, for example, 8 steps, of the focus motor M_{F} (see FIG. 3) and updates a maximum focus value whenever the focus value is calculated.

Then, the DCP 507 determines whether the focus value calculated in the scanning operation (S1302) is in an increasing or a decreasing state using the maximum value of the first reference characteristic curve C1 (see FIG. 14) whenever the focus values are calculated (S1303). In more detail, if the calculated focus value is more than a first reference percentage less than a maximum focus value of the first reference characteristic curve C1, the DCP 507 determines that the calculated focus value is in the increasing state, and if not, the DCP 507 determines that the calculated focus value is in the decreasing state. Here, the first reference percentage of the first reference characteristic curve C1 is in the range of 10-20% because, at this percentage, there is a high probability that a location where the current focus value is obtained is not near a location where a final set maximum focus value will be obtained, and when the location where the current focus value is obtained is not exist near the location where the final set maximum focus value will be obtained, it is because there is little difference between focus values at adjacent locations of the focus lens FL.

When the calculated focus value is determined to be in a decreasing state (S1304), a location of the currently renewed maximum focus value is assumed to be a location of a maximum focus value for all regions in which the focus lens FL moves. Accordingly, the DCP 507 determines a location of a maximum focus value using the second reference characteristic curve C2 (see FIG. 14) (S1305). Here, the macro-mode scanning or normal-mode scanning performed in the scanning operation (S1302) that was performing is stopped, and scanning is performed in a second number of driving steps that is less than the first number of driving steps, for example, 1 step, at a region adjacent to the location where the maximum focus value is obtained, and a final location of the focus lens FL is set. In more detail, the DCP 507 calculates a focus value proportional to an amount of high frequencies of an image signal in a 1 step unit of the focus motor M_{F}, and renews a maximum focus value of the calculated focus values whenever a focus value is calculated. Then, whenever a focus value is calculated, it is determined whether the calculated focus value is in an increasing or decreasing state using the second reference characteristic curve C2. In more detail, if the calculated focus value a second reference percentage is less then a maximum focus value of the second reference characteristic curve C2, the DCP 507 determines that the calculated focus value is in the decreasing state, and if not, the DCP 507 determines that the calculated focus value is in the increasing state. Here, the second reference percentage of the second reference characteristic curve C2 is higher than the first reference percentage because there is a big difference between focus values of adjacent locations of the focus lens FL near the location where the finally set maximum focus value is obtained. If the calculated focus value is determined to be in the decreasing state, a location where the currently renewed maximum focus value is obtained is set as a location of a maximum focus value for all regions in which the focus lens FL moves.

Meanwhile, if the calculated focus value is determined to be in the increasing state in S1304, a location where the currently renewed maximum focus value is obtained is not assumed to be a location where a maximum focus value for all regions in which the focus lens FL moves is obtained. Accordingly, the scanning operation (S1302) that is being performed and the following operations are continually performed.

The initializing of the automatic focusing step S1301 of FIG. 13 will now be described with reference to FIG. 15.

Referring to FIG. 15, when a macro mode is initiated by a user (S1501), the number of location steps of the focus motor M_{F} (see FIG. 3) corresponding to a start location from which the focus lens FL (see FIG. 4) starts to move is set to the number of location steps corresponding to a distance of 30 cm from a subject, and the number of location steps of the focus motor M_{F} corresponding to a stop location at which the movement of the focus lens FL stops is set as the number of location steps corresponding to a distance of 80 cm from the subject. Also, the number of driving steps of the focus motor M_{F} is set to 8, and the number of location steps of the focus motor M_{F} corresponding to a boundary location of the focus lens FL is set by doubling the number of driving steps (8) and adding with the number of location steps of the focus motor M_{F} corresponding to the location at which the movement of the focus lens FL stops (S1502).

When a normal mode is initiated by a user (S1501), the number of location steps of the focus motor M_{F} corresponding to a start location from which the focus lens FL starts to move is set to the number of location steps corresponding to an infinite distance from a subject, and the number of location steps of the focus motor M_{F} corresponding to a stop location at which the movement of the focus lens FL stops is set to the number of location steps corresponding to a distance of 80 cm from the subject. Also, the number of driving steps of the focus motor M_{F} is set to 8, and the number of location steps of the focus motor M_{F} corresponding to a boundary location of the focus lens FL is set by doubling the number of driving steps (8) and subtracting it from the number of location steps of the focus motor M_{F} corresponding to the location at which the movement of the focus lens FL stops (S1503). Here, the boundary location need not be used.

Then, the DCP 507 drives the focus motor M_{F} via the micro-controller 512 (see FIG. 3), and thus moves the focus lens to the start location from which the focus lens FL starts to move (S1504).

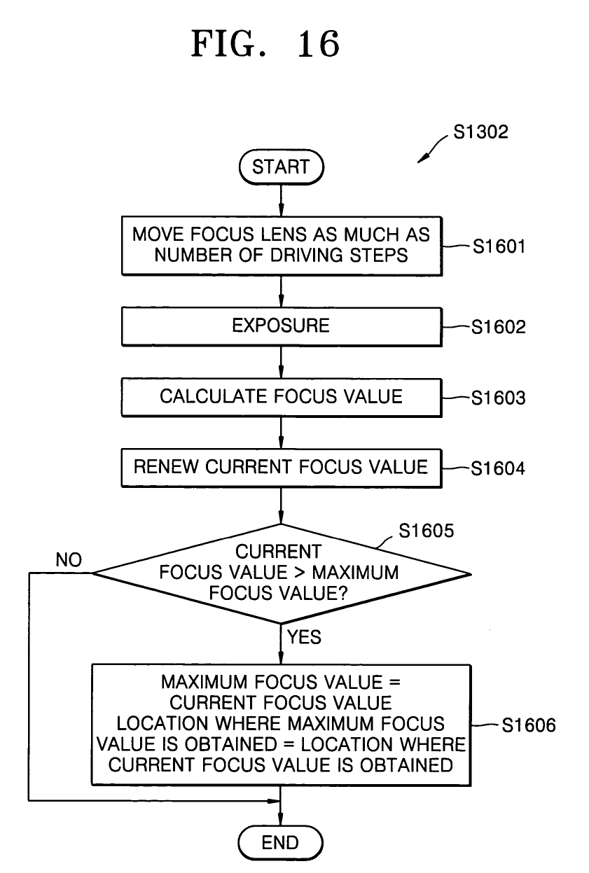

Referring to FIG. 16, the scanning step S1302 of FIG. 13 will be described in detail.

First, the DCP 507 moves the focus motor M_{F} as much as the number of driving steps via the micro-controller 512, and thus moves the focus lens FL (S1601).

The DCP 507 drives the aperture motor M_{A} via the micro-controller 512 and exposes the photoelectric converter OEC (see FIG. 4). The DCP 507 processes frame data output from the CDS-ADC 501 (see FIG. 3) and calculates a focus value that is proportional to an amount of high frequencies in the frame data (S1603). Then, the DCP 507 renews a current focus value with the calculated focus value (S1604). If the current focus value is higher than a maximum focus value (S1605), the maximum focus value is renewed as the current focus value, and a location where the maximum focus value is obtained is renewed as the location where the current focus value is obtained (S1606).

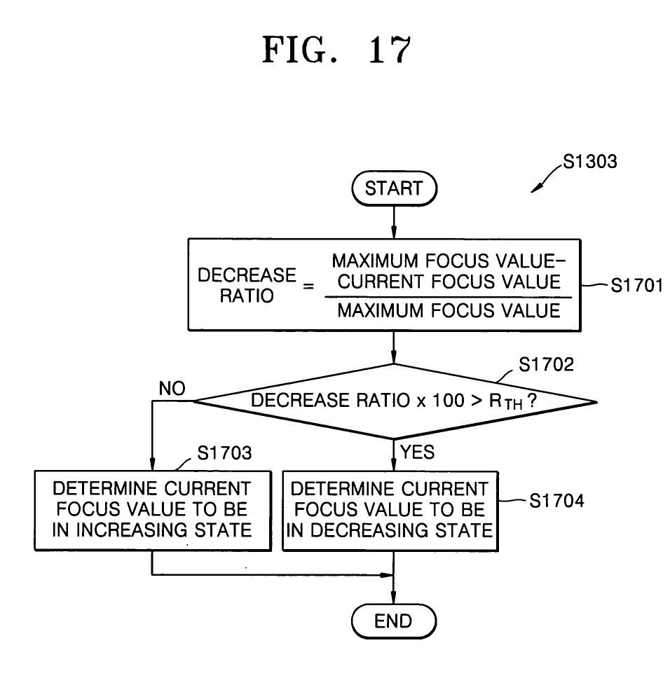

Referring to FIG. 17, the determination of the state of the calculated focus value step S1303 of FIG. 13 will now be described in detail.

First, the DCP 507 calculates a decrease ratio using Equation 1 (S1701).

$$Decrease Ratio = \frac{Maximum Focus Value - Current Focus Value}{Maximum Focus Value} \qquad ( 1 )$$

Then, if a decrease percentage, which is 100 times the decrease ratio, is higher than a first reference percentage R_{TH} of the first reference characteristic curve C1 (see FIG. 14), the DCP 507 determines that the calculated focus value is in a decreasing state (SI702 and S1704). If the decrease percentage is lower than the first reference percentage R_{TH}, the DCP 507 determines that the calculated focus value is in an increasing state (S1702 and S1703).

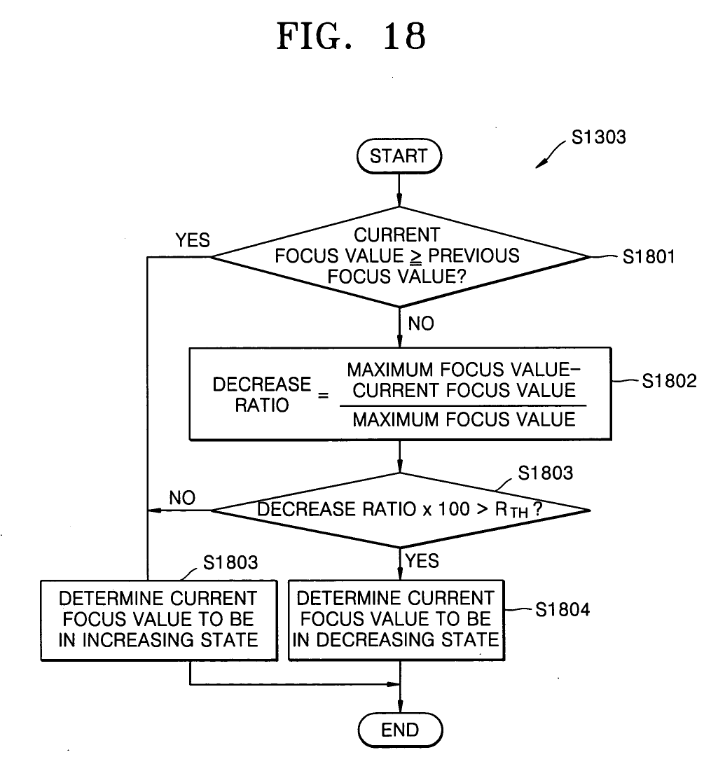

Referring to FIG. 18, the determination of the state of the calculated focus value step S1303 of FIG. 13 will now be described according to another embodiment of the present invention. The operation illustrated in FIG. 18 can determine the state of the calculated focus value in more detail than the operation illustrated in FIG. 17.

First, the DCP 507 determines that a current focus value is in an increasing state if the current focus value is higher than a previous focus value, and terminates the operation if the current focus value is higher than the previous focus value (S1801 and S1804).

If the current focus value is less than the previous focus value, the DCP 507 performs the following operations.

The DCP 507 calculates a decrease ratio using Equation 1 above (S1802). If the decrease percentage, which is 100 times the decrease ratio, is higher than the first reference percentage R_{TH} of the first reference characteristic curve C1 (see FIG. 14), the DCP 507 determines that the current focus value is in an increasing state (S1803 and S1805), and if not, the DCP 507 determines that the current focus value is in a decreasing state (S1803 and S1804).

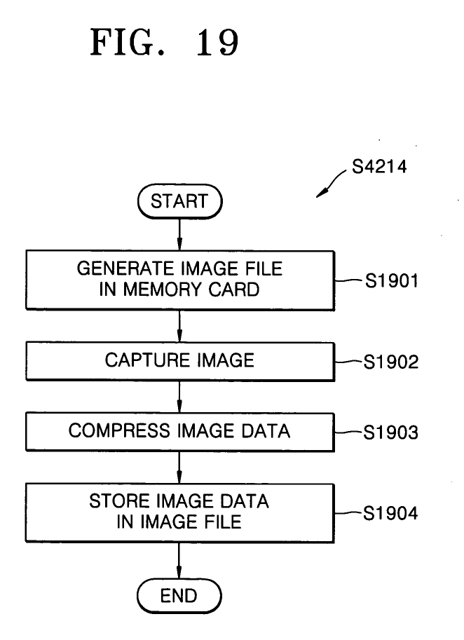

FIG. 19 illustrates the photographing (S4214) described with reference to FIG. 8. Referring to FIGS. 3 and 19, the photographing (S4214) will now be described.

First, the DCP 507 generates an image file in a memory card, which is a recording medium (S1901). Then, the DCP 507 continually captures an image (S1902). That is, the DCP 507 receives image data from the CDS-ADC 501. Then, the DCP 507 compresses the received image data (S1903), and stores the compressed image data in the image file (S1904).

As described above, according to a method of controlling a digital photographing apparatus and a digital photographing apparatus using an embodiment of the present invention, automatic focusing is performed at an input location region according to an voice command received in a photographing mode. Thus, a user may conveniently select the input location region for automatic focusing when photographing. In addition, according to an embodiment of the invention, the voice command is recognized only when a shutter release button is pressed to a first step. Therefore, a burden on a controller due to a voice recognition operation is reduced and accuracy of the voice recognition is increased.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of controlling a digital photographing apparatus, the method comprising:
receiving an image of a subject that is to be photographed;
in response to a shutter release button being pressed, by a user, recognizing a voice command input by the user, wherein the voice command indicates a region of the image;
automatically focusing on the indicated region in response to the recognized voice command; and
photographing the subject.

2. The method of claim 1, wherein the recognizing step is performed in response to the shutter release button being pressed to a first position, and wherein the photographing step is performed in response to the shutter release button being pressed to a second position.

3. The method of claim 1, wherein the voice command further indicates that the subject is to be photographed, and wherein the photographing step is performed in response to the voice command.

4. The method of claim 1, wherein the recognizing step comprises determining whether the voice command correlates with voice modeling data.

5. The method of claim 1, further comprising:
determining that the digital photographing apparatus is in a voice recognition mode; and
performing the recognizing step in response to both the shutter release button being pressed and based on the determining step.

6. The method of claim 1, further comprising:
presenting, to the user, the option of indicating whether the voice command is male or female; and
receiving, from the user, an indication of whether the voice command is male or female.

7. The method of claim 1, further comprising:
presenting a menu to the user on a display screen, wherein the menu gives the user the option to put the digital photographing apparatus into a voice recognition mode; and
receiving, from the user via the menu, an indication that the digital photographing apparatus is to be put into voice recognition mode.

8. The method of claim 7, wherein the menu gives the user the further option of specifying whether the user is male or female, the method further comprising receiving, from the user via the menu, an indication of whether the user is male or female.

9. The method of claim 1, wherein the region of the image is one of a plurality of regions of the image, and wherein the voice command indicates a relative direction within the image that distinguishes the region from the rest of the plurality of regions.

10. The method of claim 1, wherein the voice command comprises a first part and a second part, wherein the photographing step is performed in response to the first part and the focusing step is performed in response to the second part.

11. A digital imaging apparatus, the apparatus comprising:
an optical system that receives light from a subject to be photographed by the apparatus;
a digital processor that receives signals representing the light received by the optical system and generates an image based on the light signals;
an audio processor that processes signals representing sounds and provides the sound signals to the digital processor;
an autofocus mechanism; and
a shutter release mechanism,
wherein, in response to the user issuing a voice command and manipulating the shutter release mechanism, the audio processor processes signals representing the voice command and provides the voice command signals to the digital processor, and
wherein, in response to receiving the voice command signals, the digital processor causes the autofocus mechanism to focus on a portion of the image that is specified in the voice command.

12. The apparatus of claim 11, further comprising a microcontroller and a driving unit, wherein the digital processor causes the autofocus mechanism to focus on the portion of the image by sending a command to the microcontroller which, in turn, sends signals to the driving unit which, in response, moves the autofocus mechanism to a position so as to focus on the specified portion of the image.

13. The apparatus of claim 11, wherein the digital photographing apparatus photographs the subject in response to the voice command.

14. The apparatus of claim 11,
wherein the shutter release mechanism has a first position and a second position, and wherein the audio processor processes signals representing the voice command and provides the voice command signals to the digital processor in response to the user manipulating the shutter release mechanism into the first position, and
wherein the digital photographing apparatus photographs the subject in response to the user manipulating the shutter release mechanism into the second position.

15. The apparatus of claim 11, further comprising a mode selection mechanism that allows the user to put the apparatus in at least a voice recognition mode and a non-voice recognition mode.

16. The apparatus of claim 11, further comprising a photoelectric converter that converts light received by the optical system into electrical analog signals.

17. A digital camera comprising:
means for receiving an image of a subject that is to be photographed;
means for recognizing, in response to a shutter release button being pressed, by a user, a voice command input by the user, wherein the voice command indicates a region of the image;
means for automatically focusing on the indicated region in response to the recognized voice command; and
means for capturing an image of the subject.

18. The digital camera of claim 17, wherein the recognizing means comprises a microphone and an audio processor, wherein the microphone converts sound into electrical signals and the audio processor processes the electrical signals.

19. The digital camera of claim 17, wherein the focusing means comprises a microcontroller, a driving unit, and a focusing motor, wherein the microcontroller issues commands to the driving unit, which, in turn sends electrical signals to the focusing motor which, in turn, actuates an optical system.

20. The digital camera of claim 17, wherein the capturing means comprises an optical system and a photoelectric converter, wherein the optical system receives light from the subject, and the photoelectric converter converts the light into analog electrical signals.
